(19) United States
(12) Patent Application Publication
(10) Pub. No.: US 2017/0152789 A1
(43) Pub. Date: Jun. 1, 2017

(54) FAN DRIVE WITH IMPROVED VARIABLE SLIPPAGE CLUTCH UNIT FOR AN INTERNAL COMBUSTION ENGINE

(71) Applicant: CNH Industrial America LLC, New Holland, PA (US)

(72) Inventors: Alessandro Benevelli, Albinea (IT); Silvio Natali, Modena (IT)

(21) Appl. No.: 15/365,275

(22) Filed: Nov. 30, 2016

(30) Foreign Application Priority Data
Dec. 1, 2015 (IT) UB2015A006050

(51) Int. Cl. F01P 7/04; F04D 29/32; F16H 35/10; F16H 3/089; F16H 9/04; F01P 5/04; F04D 27/00

(52) U.S. Cl. CPC F01P 7/042; F01P 5/04; F04D 29/329; F04D 27/004; F16H 3/089; F16H 9/04; F16H 35/10

(57) ABSTRACT

A fan drive for a working vehicle includes a speed shift unit and a fan in series to the speed shift unit. The speed shift unit includes a clutch unit and is configured to discretely provide a first non-zero speed ratio and a second non-zero speed ratio. The clutch unit is configured to alternatively connect the first or the second non-zero speed ratio to the fan.

The present invention relates to a fan drive for an internal combustion engine, in particular for an internal combustion engine provided in agricultural vehicles, such as harvesters, tractors and the like, or construction vehicles, such as loaders, excavators and the like.

### BACKGROUND OF THE INVENTION

A fan drive is normally provided in a cooling system of an internal combustion engine. In particular a fan is used to provide an air flow for cooling a diesel engine of a working vehicle, such as an agricultural vehicle or a construction vehicle.

The fan is designed to provide the appropriate cooling effect in the most severe working condition of the IC engine. The latter however seldom occurs so that power absorption of the fan is excessively high during other working conditions.

It is known to provide a variable slippage fluid clutch to couple in a torque transfer mode a driving shaft of the internal combustion engine to the fan in order to control the rotating speed of the fan with respect to the rotating speed of the driving shaft and thus decrease power absorption. For example, when the IC engine is started from a cold condition, e.g. when the vehicle is parked and the IC engine is substantially at the environment temperature, the clutch unit is controlled so that the fan has a low or null rotational speed. Without a significant cooling from the fan, the engine quickly reaches a predefined optimal working temperature, thus reducing low efficiency transients. In addition, power is saved when the fan is stopped or rotates at low speed. Reduction of the fan speed with respect to the driving shaft can also be operated during running of the vehicle according to known control strategies.

Efficiency of a fluid variable slippage clutch is in general satisfactory. However there are certain fan working conditions wherein the clutch shall transfer an intermediate level of torque, e.g. the fan is at a medium range speed, and at the same time the driving shaft speed is relatively high. In such a working condition a non negligible amount of power is wasted due to the combination of slippage an transferred torque. It is therefore the scope of the present invention to further decrease power consumption of a fan driven by a fluid slippage clutch unit and, at the same time, to provide an effective cooling to the IC engine in all working conditions.

### SUMMARY OF THE INVENTION

The scope of the present invention is achieved with a fan drive for a working vehicle comprising a fluid slippage clutch and a fan in series to the fluid slippage clutch and a speed shift unit connected in series to the fan and the fluid slippage clutch and configured to discretely provide a first non-zero speed ratio and at least a second non-zero speed ratio, the speed shift unit comprising a clutch unit having a first and at least a second clutch configured to alternatively connect the first or the second non-zero speed ratios to the fan.

Additional features of the invention are comprised in the dependent claims. In particular a control unit of the fan drive is programmed to efficiently switch between a slippage fan speed control mode operated by the fluid slippage clutch and a modulating fan speed control mode operated by the speed shift unit.

Furthermore, a retrofit method is provided in order to upgrade an existing fan drive provided with an existing fluid slippage clutch connected in series to the fan.

### BRIEF DESCRIPTION OF THE DRAWINGS

For a better understanding of the present invention, the latter will further be disclosed with reference to the accompanying figures in which:

FIGS. 1a, 1b and 1c are respective schematic views in different working conditions of a fan drive according to the present invention;

FIG. 2 is a plot of characteristic curves of power absorbed by the fan according to different control strategies;

FIG. 3 is a flowchart of a preferred control strategy of the fan drive in FIG. 1; and

FIG. 4 is a comparison of the power loss over the fan rotating speed according to prior art and after implementation of a control strategy according to FIG. 3.

### DETAILED DESCRIPTION OF THE DRAWINGS

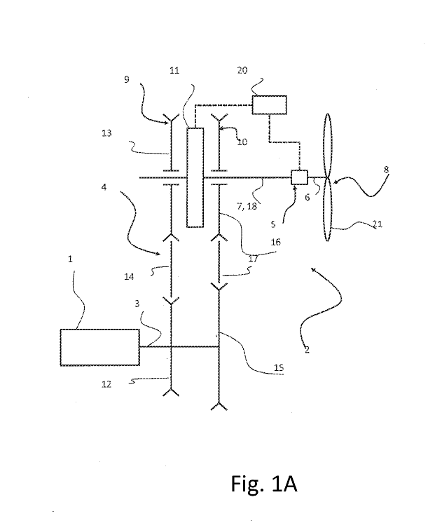

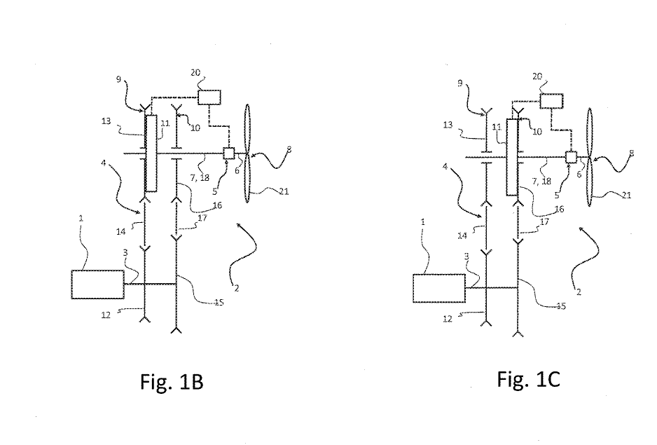

In FIG. 1, numeral 1 refers to an internal combustion engine for a working vehicle that is cooled by a fan drive 2 driven by a shaft 3 of IC engine 1. Shaft 3 is connected with a fixed speed ratio to a crankshaft of IC engine 1.

Fan drive 2 comprises, in series, a discrete speed shift unit 4 configured to define at least a first and a second non-zero speed ratio SR1, SR2 and possibly a neutral or zero ratio SR0, a fluid or wet slippage clutch 5 controllable so that speed of an output shaft or member 6 lags or pairs the speed of an input shaft or member 7, and a fan 8 driven by speed shift unit 4 and fluid slippage clutch 5.

Discrete speed shift unit 4 comprises, according to a preferred embodiment of the invention, a first endless flexible drive 9 defining the first speed ratio, a second endless flexible drive 10 set in parallel to first endless flexible drive 9 with respect to shaft 3 and defining the second speed ratio, and a clutch unit 11 to select whether fan 8 is driven either by the first endless flexible drive 9 or by the second endless flexible drive 10. In particular, alternative connection of either endless flexible drive 9 or endless flexible drive 10 is operated by clutch unit 11 that preferably comprises a first and a second on-off clutch each of which is placed in order to selectively connect endless flexible drive 9 or endless flexible drive 10 to fan 8. Each on-off clutch initially slips during transients when connecting either endless flexible drive 9 or endless flexible drive 10 to fan 8 (FIG. 1 shows only a functional sketch). Preferably, slippage is dry slippage obtained by one or more friction disks. Each clutch can be hydraulic, electro-magnetic or purely mechanical.

According to FIG. 1, first endless flexible drive 9 comprises a driving pulley 12 connected in a torque transmitting manner to shaft 3, a driven pulley 13 and a belt 14 to connect in a torque transmitting manner pulley 12 to pulley 13. Second endless flexible drive 10 comprises a driving pulley 15 connected in a torque transmitting manner to shaft 3 in parallel to pulley 12, a driven pulley 16 and a belt 17 to connect in a torque transmitting manner pulley 15 to pulley 16.

Shift unit 4 also comprises a driven shaft 18 to which pulleys 13 and 16 are selectively connected in a torque transmitting manner by clutch unit 11 in order to control the speed of fan 8. In particular, pulleys 13, 16 are free to rotate with respect to driven shaft 18; and clutch unit 11, in a discrete and selective manner, connects either pulley 13 or pulley 16 to driven shaft 18 whilst the other one freely rotates with respect to shaft 18 (FIG. 1b). When discrete speed shift unit 4 is in the neutral ratio SR0 and shaft 3 is rotating, both pulleys 13, 16 freely rotate with respect to shaft 18 that, in such a condition, is disengaged from driving shaft 3 so that fan 8 is stopped or at a minimum speed.

According to FIG. 1, pulleys 12 and 15 have different diameters and pulleys 13, 16 have the same diameter in order to define first and second speed ratio SR1, SR2. However other suitable combinations of diameters are possible in order to have first speed ratio SR1 different from second speed ratio SR2. One of the first and second speed ratio can be unitary and the other one is either below or above 1 depending on the IC engine models.

It is also possible to provide drives 9, 10 with chain and sprockets (not shown) having the same functions as pulleys 12, 13, 15, 16 and belts 14, 17.

Furthermore it is also possible that discrete shift unit 4 defines first and second speed ratio and, possibly, neutral ratio by means of gears or a combination of gear drives and endless flexible drives.

Discrete shift unit 4 has a high torque transfer efficiency, i.e. ratio between power available on shaft 18 and power applied to shaft 3. Torque transfer efficiency does not take into consideration power absorbed for control and actuation of the components, i.e. power absorbed to switch clutch unit 11. Depending on design requirements, minimum torque transfer efficiency of shift unit 4 can be either 90% or higher. For example, efficiency of belt drives 9, 10 can be 95% or higher. Furthermore efficiency of shift unit 4 remains constant over rotation speed range of fan 8.

According to FIG. 1, discrete shift unit 4 is upstream to fluid slippage clutch 5 along the torque flow from shaft 3 to fan 8.

Fluid slippage clutch 5 can be for example a mechanically controlled fluid friction clutch having input shaft 7 and output shaft 6 connected to respective armatures (not shown) inside a working chamber filled with a viscous fluid, for example a silicone-based oil. In particular, in a fluid friction clutch, rotational movement is transmitted to the viscous fluid from the armature connected to input shaft 7; and to the armature connected to output shaft 6 from the viscous fluid, for example by shear forces within the fluid. Mechanical control can be implemented via a hydraulic control valve to set the slip of the fluid friction clutch based on metering the amount of viscous fluid within the working chamber. For example, when the valve is open and input shaft 6 is running, viscous fluid tends to leak out the working chamber so that armatures can more easily slip one with respect to the other and a low torque is thus transmitted. When the valve is closed after a large amount of viscous fluid is injected in the working chamber, the fluid is trapped and transmitted torque increases, thus lowering slippage.

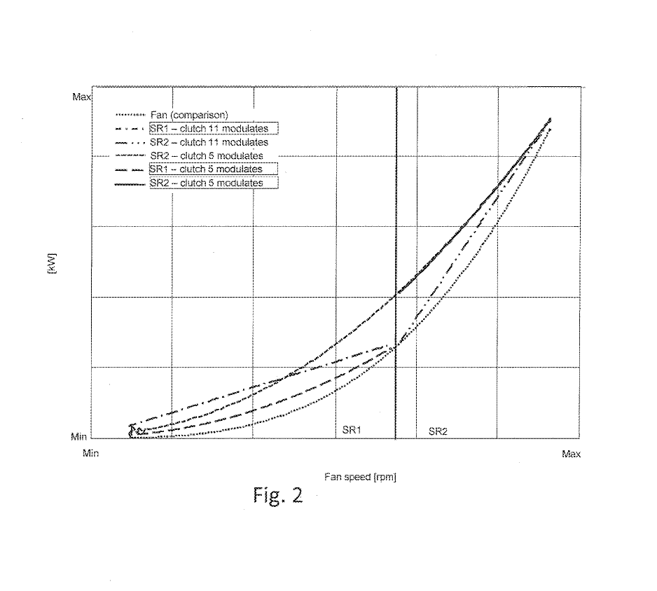

In view of the above, fluid slippage clutch 5 has an efficiency that is continuously variable depending on the working condition of fan 8. In particular, throughout the speed range of fan 8, torque transfer efficiency of fluid slippage clutch 5 ranges from a maximum to a minimum of approximately 65% excluding power absorption for the actuation of the valve. The maximum efficiency is reached when either transmitted torque is low and slippage is maximum, i.e. the fan is stopped or at its minimum speed, or transmitted torque is maximum and slippage is low, i.e. the fan is at its maximum speed. Minimum efficiency is experienced where, approximately at mid fan speed range, both slippage and transmitted torque are at an intermediate level. This is also qualitatively shown in FIG. 2 where, as it will be explained in greater detail below, dashed curve and dotted curve are proximal at both maximum and minimum fan speed and, from such endpoints, progressively depart one from the other to reach a maximum difference in an intermediate speed range.

Fluid slippage clutch 5 is controllable by a discrete control such that valve pulsates between an open an a closed position. This can be implemented by an ON/OFF valve controlled by a PWM controller. Other controls are applicable, for example a proportional control of a servovalve.

According to the embodiment of FIG. 1, input shaft 7 of fluid slippage clutch 5 is rigidly connected to, and preferably a single body with, driven shaft 18. Fan 8 is connected in order to rotate at the same speed as that of output shaft 6.

Fluid slippage clutch 5 and clutch unit 11 are controlled by an electronic control unit 20 that may be dedicated to the control of fan drive 2 or be embedded in an electronic control system of IC engine 1.

According to a preferred embodiment, fan 8 is a fixed blade fan, i.e. blades 21 have a fixed orientation when fan 8 is stopped. As an alternative, fan 8 may comprise rotatable blades configured to change the pitch of fan 8. Furthermore, fluid slippage clutch 5 is surrounded by blades 21 in order to reduce axial dimension. To this regard, output shaft 6 and input shaft 7 can be substituted by mechanical members having different shapes. For example, output member 6 can be shaped as a hub of fan 8 and input member 7 can be a flange for connection with shift unit 4.

FIG. 2 compares different fan power consumptions of fan drive 2 over the fan working speed compared to the power consumption (dotted) of a theoretical condition where fan 8 is rigidly connected to shaft 3 and IC engine 1 ramps up. In particular:
Dashed curve shows power consumption of the combination of fan 8 and fluid slippage clutch 5 where engine 1 is kept at a high constant speed, shift unit 4 is switched at SR2 and slippage clutch 5 is controlled to ramp up the speed of fan 8;
Large dashed curve shows power consumption of the combination of fan 8 and slippage clutch 5 when shift unit 4 is switched at SR1, SR2 being greater than SR1, and speed of IC engine 1 is constant as above. Ramping of the fan is obtained by controlling slippage clutch 5;
Continuous curve (partially superimposed to dashed curve) shows power consumption of the combination of fan 8, slippage clutch 5 when shift unit 4 is switched at SR2 and speed of IC engine 1 is constant as above. Ramping of the fan is obtained by controlling slippage clutch 5;
Dash-dot line shows power consumption when slippage clutch 5 is fully engaged, i.e. minimum or null slippage, and clutch unit 11 is controlled to selectively switch, e.g. pulse-width modulate, between SR0 and SR1 in order to obtain a predefined characteristic curve. Modulation between SR0 and SR1 can be controlled such that the line is rectilinear;
Dash-dot-dot line shows power consumption when slippage clutch 5 is fully engaged, i.e. minimum or null slippage, and clutch unit 11 is controlled, e.g. modulated, between SR1 and SR2 as discussed above for SR0 and SR1.

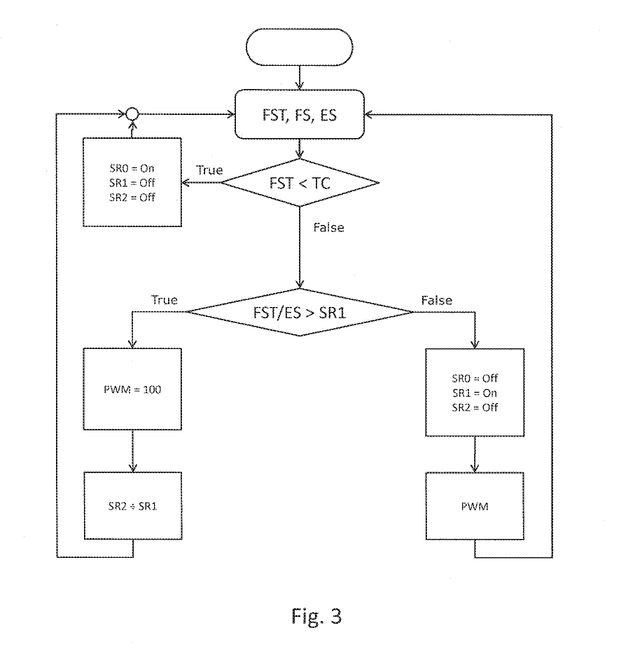

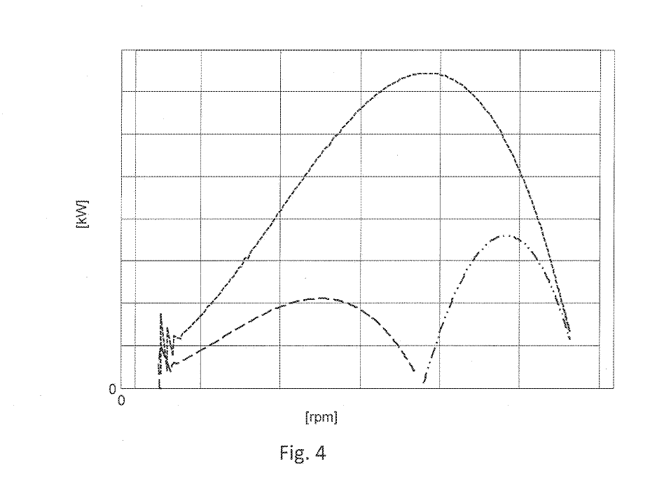

According to a preferred control method of fan drive 2 (FIG. 3), control unit 20 determines a target speed FST of fan 8 and checks whether the ratio of FST and the speed of shaft 3 ES is higher than SR1.

In the affirmative, fluid slippage unit 5 is set to a maximum torque transfer mode, i.e. full engagement, and control unit 20 switches clutch unit 11, i.e. between SR1 and SR2, in order to follow the predetermined characteristic curve that can be rectilinear, e.g. dash-dot-dot of FIG. 2. When fluid slippage clutch 5 is PWM controlled, full engagement of clutch 5 is realized by setting the maximum amount of fluid in the working chamber and by fully closing the control valve for the 100% of the working cycle (PWM=100 in left branch of FIG. 3).

In the negative, SR1 is set and the fan speed is controlled through fluid slippage clutch 5, e.g. according to modulation with a non 100% working cycle of the control valve, to follow FST. This corresponds to large dashed line of FIG. 2.

As shown in FIG. 3 the fan speed FS is controlled in closed loop.

According to an option, also included in FIG. 3, control unit 20 checks whether FST is lower than a predefined speed threshold, e.g. threshold TC for cold starting of IC engine 1. Control unit 20 checks for cold starting before checking whether the ratio of FST and the speed of shaft 3 ES is higher than SR1. In case FST is lower than TC, control unit 20 ensures that shift unit 4 is in the neutral ratio SR0, i.e. driven shaft 18 is disconnected from shaft 3. In such a condition, fan 8 is stopped or rotates at its minimum speed. In the negative, ratio FST/ES is checked over SR1 and the above paragraphs apply.

According to the method of the preceding paragraphs power consumption is optimized both in a lower fan speed range and a higher fan speed range. This is confirmed by the large dashed line and the dash-dot-dot line that are close to dotted line, which represents a condition where efficiency of transmission between shaft 3 and fan 8 is unitary. This is because the dotted line refers to a layout where fan 8 is rigidly connected to shaft 3. In particular, along large dashed curve, dissipation is reduced because slippage occurs at a lower speed. Along dash-dot-dot line, dissipation is reduced because the modulation between SR1 and SR2 is operated at higher efficiency, i.e. excluding fluid slippage.

It is however possible to control fan drive 2 to introduce the benefit discussed above either at lower or at higher speed range only.

Advantages of fan drive 2 according to the present invention are as follows.

Speed shift unit 4 introduces a discrete double speed range within fan drive 2 that is simple to implement and at the same time advantageous, depending on the control strategy, to reduce power losses due to slippage of fluid slippage clutch 5. In particular, due to SR1 and SR2 it is possible to design a fan drive having characteristic curves that either are below, e.g. large dashed curve, the characteristic curve relative to a slippage only control, i.e. dashed curve of FIG. 2; or intercept such dashed curve and extend in a region of increased efficiency. Furthermore, provision of clutch unit 11 to switch between SR1 and SR2 ensures, due to slipping of clutch unit 11 during transients of connection, the implementation of a wide range of control strategies in combination with fluid slippage clutch 5. This is because connection of either one of endless flexible drives 9, 10 to fan 8 is possible over a broad range of relative speed between fan 8 and shaft 3. This ensures an advantage over speed shifts comprising e.g. synchronizers because in such a case the switch between one gear ratio to another can be operated only over limited ranges of relative speed.

Speed shift unit 4 is upstream of fluid slippage clutch 5 in order to reduce the impact on existing fan drives where the fluid slippage clutch 5 is attached to fan 8. In order to retrofit an existing fan drive it is only necessary to fit speed shift unit 4 between shaft 3 and input shaft or member 7. In particular, existing fan drives comprise fixed blades 21 surrounding fluid slippage clutch 5 and attached directly to output member 6, which is therefore the hub of fan 8. Furthermore fluid slippage clutch unit 5, being in series to shift unit 4, helps to smooth the noise during shifting of unit 4, in particular when unit 4 modulates along dash-dot line and/or dash-dot-dot line of FIG. 2. Provision of neutral ratio SR0 provides an additional flexibility of fan drive 2 that can also implement a power saving strategy for cold start of IC engine 1.

In order to increase efficiency it is preferable that speed shift unit 4 has a minimum torque transfer efficiency greater than that of fluid slippage clutch 5. In particular, speed shift unit 4 may comprise belt drives, either friction or synchronous, or chain drives or gears in order to provide SR1 and SR2.

In order to provide a simple control, either shift unit 4 or slippage clutch 5 or both are configured to be controlled and are indeed controlled according to a pulse width modulation strategy. Actuation of shift 4 or slippage clutch 5 can be either electric, hydraulic, mechanic, magnetic or any combination thereof.

Provision of on-off clutches within clutch unit 11 makes PWM control easier to implement.

Finally it is clear that modifications may be made to the fan drive disclosed and shown herein without departing from the scope of protection defined by the appended claims.

According to an alternative embodiment, fluid slippage clutch 5 comprises a magnetoreological fluid that changes its viscosity depending on a variable magnetic field interacting with the fluid and generated for example by electromagnetic coils. When a magnetoreological fluid is used in a fluid slippage clutch, the functioning and the structure are similar to those of a fluid friction clutch except that a fixed amount of fluid fills the working chamber and the level of slippage is mainly controlled by changing the viscosity of the fluid through a variable magnetic field.

It is possible to provide clutch unit 11 on shaft 3 so that, in neutral speed ratio SR0, also pulleys 13 and 16 are stopped.

According to a further embodiment, fluid slippage clutch 5 can be omitted and, in such a case, fan 8 is rigidly connected to driven shaft 18. Accordingly, the power absorbed by fan 8 is shown by dash-dot and dash-dot-dot lines of FIG. 2.

According to a non-illustrated embodiment, speed shift 4 may also be configured to provide a third gear ratio. This will further improve efficiency. In case of third gear ratio, a further belt or chain shall be provided in parallel to belts 14 and 17 with respect to shaft 3. A further clutch, in particular an on-off clutch, functionally identical to those of clutch unit 11 shall be provided in order to provide modulation and, if the case, also full disengagement to stop fan 8 when cold starting of IC engine 4.

1. A fan drive for a working vehicle comprising:
a fluid slippage clutch;
a fan in series to the fluid slippage clutch; and
a speed shift unit connected in series to the fan and the fluid slippage clutch, wherein the speed shift unit is configured to discretely provide a first non-zero speed ratio and a second non-zero speed ratio, and the speed shift unit comprises a clutch unit having a first and a second clutch configured to alternatively connect the first or the second non-zero speed ratio to the fan.

2. The fan drive according to claim 1, wherein the speed shift unit is configured to further provide a neutral ratio such that the speed shift unit is rotationally disconnected from the fluid slippage clutch.

3. The fan drive according to claim 1, comprising a control unit configured to selectively cause a modulation of the first and second clutches to alternatively connect the first or the second non-zero speed ratio to the fan.

4. The fan drive according to claim 3, wherein the control unit is configured to control the fan either by modulation between the first and the second non-zero speed ratios, the fluid slippage clutch being at maximum engagement or by controlling the fluid slippage clutch, the speed shift unit being set at a lower of the first and second non-zero speed ratios, depending on a speed range of the fan.

5. The fan drive according to claim 2, comprising a control unit configured to determine whether a target fan speed is lower than a threshold and, in the affirmative, instruct the speed shift unit to connect the neutral speed ratio to the fan.

6. The fan drive according to claim 1, wherein the speed shift unit is upstream of the fluid slippage clutch along a torque flow to the fan.

7. The fan drive according to claim 1, wherein the speed shift unit has a minimum torque transfer efficiency higher than that of the fluid slippage clutch.

8. The fan drive according to claim 1, wherein the speed shift unit comprises at least one of an endless flexible drive and a gear drive that provides one of the first and second non-zero speed ratios, a respective one of the first and second clutches of the clutch unit being configured to selectively connect the endless flexible drive or the gear drive to the fan.

9. The fan drive according to claim 1, wherein the fan comprises blades, and the blades surround the fluid slippage clutch.

10. A retrofit method of a working vehicle having an internal combustion engine, a fluid slippage clutch connected to a driving shaft of the IC engine, and a fan connected to the fluid slippage clutch, comprising the step of connecting a speed shift unit in series between the driving shaft and the fluid slippage clutch, wherein the speed shift unit is configured to discretely provide a first non-zero speed ratio and a second non-zero speed ratio, and the working vehicle comprises a clutch unit having a first and a second clutch configured to alternatively connect the first or the second non-zero speed ratio to the fan.

11. The fan drive according to claim 1, wherein at least one of the first and second clutches of the clutch unit is an on-off clutch.
